(19) United States
(12) Patent Application Publication
(10) Pub. No.: US 2005/0228921 A1
(43) Pub. Date: Oct. 13, 2005

(54) Sharing of interrupts between operating entities

(76) Inventors: Prashant Sethi, Folsom, CA (US); Jose A. Vargas, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/815,431

(22) Filed: Mar. 31, 2004

(51) Int. Cl. G06F 13/24

(52) U.S. Cl. 710/268

(57) ABSTRACT

Techniques for selectively forwarding interrupt signals to virtual machines.

### TECHNICAL FIELD

Embodiments of the invention relates to support for operating entities such as virtual machines or threads. More particularly, the invention relates to techniques for sharing of interrupts between operating entities.

### BACKGROUND

Computer hardware and operating systems currently exist that support multiple virtual machines that can have independent operating systems and that execute applications without interaction with other virtual machines. The virtual machines may have access to different subsets of devices and/or resources provided by or through the computer hardware. FIG. 1 is a block diagram of a computer system that supports virtual machines.

Host machine 100 represents the hardware of the computer system. Host machine 100 includes, for example, one or more processors, one or more bus systems, mass storage, read-only memory, input/output devices, a power supply, etc. Host machine 100 represents the many computer systems known in the art can support virtual machines. Host monitor 110 provides an interface between the hardware of host machine 100 and virtual machines 140 and 150. Each virtual machine can have an independent operating system. For example, virtual machine 140 runs guest operating system 145 and virtual machine 150 runs guest operating system 155.

When host machine 100 receives an interrupt signal, host monitor cannot determine which virtual machine should process the interrupt. Thus, host monitor 110 forwards the interrupt message to all virtual machines. Because generally only one of the virtual machines processes the interrupt the remaining virtual machines treat the interrupt signal as a spurious interrupt signal. The context switching overhead associated with sending an interrupt signal to all virtual machines results in computational inefficiencies. These inefficiencies are compounded if one or more of the virtual machines calls an interrupt service routine (ISR) chain to process the interrupt signal, which results in multiple ISRs being called.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of a computer system that supports virtual machines.

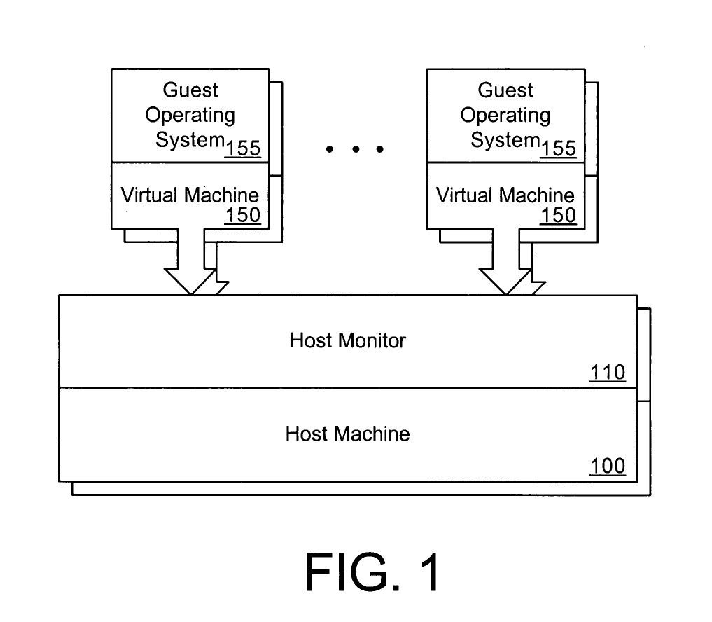

FIG. 2 is a conceptual illustration of interrupt processing using an interrupt service routine chain.

FIG. 3 is a conceptual illustration of interrupt processing with multiple virtual machines each using an interrupt service routine chain.

FIG. 4 is a conceptual illustration of interrupt processing with multiple virtual machines each using an interrupt service routine chain in which interrupt signals are selectively passed to one or more virtual machine operating systems.

FIG. 5 is a block diagram of one embodiment of a circuit for selective assertion of interrupt signals to virtual machines.

FIG. 6 is a flow diagram of one embodiment of a technique for selective assertion of interrupt signals to virtual machines.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

In many computer system architectures, devices coupled to an interconnect, for example, a Peripheral Component Interconnect (PCI) bus or a PCI Express interconnect typically share interrupt signals between multiple devices. The various PCI standards are managed by the PCI Special Interest Group of Portland, Oregon. Specific PCI standards and versions are discussed in greater detail below. Other, non-PCI standard interfaces can also provide shared interrupt signaling.

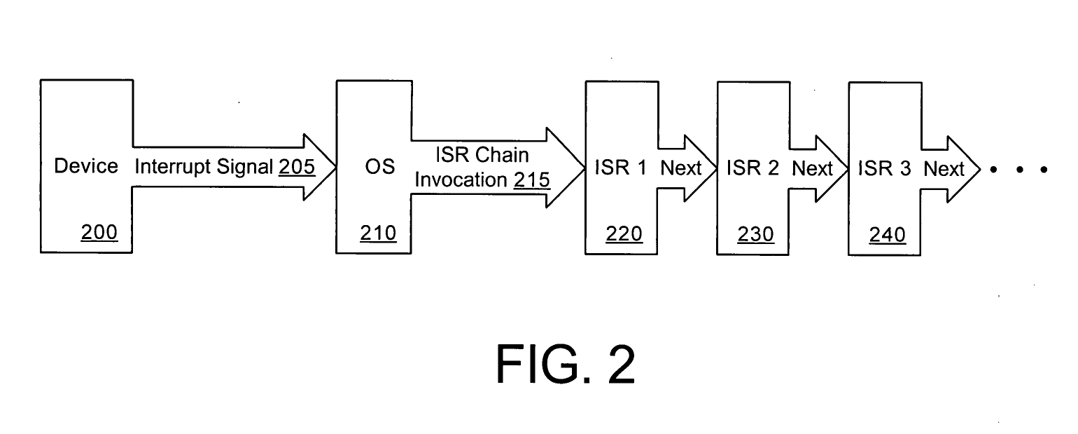

These shared signals utilize level-triggered semantics allowing multiple interrupt service routines (ISRs) to be associated with the same interrupt line. When an interrupt signal is asserted, an operating system calls all ISRs registered with the operating system (the ISR chain) for the given interrupt signal in turn until an ISR for the device asserting the signal claims the interrupt and services the interrupting device thus de-asserting the interrupt signal. An example of interrupt processing using an ISR chain for a single operating system is illustrated in FIG. 2.

Using the example of FIG. 2, device 200 generates an interrupt by asserting interrupt signal 205, which is interpreted by operating system (OS) 210. In response to interrupt signal 205, OS 210 causes ISR chain invocation 215. Receipt of interrupt signals and invocation of ISR chains is known in the art and any appropriate technique can be used. The ISR chain can include any number of ISRs including, for example, ISR 220, ISR 230 and ISR 240.

In the example of FIG. 2, it is possible that the operating system may receive a spurious interrupt due to a race condition between a device de-asserting an interrupt signal and the operating system issuing an end-of-interrupt (EOI) command to the interrupt controller. In this case, the operating system invokes the ISR chain and none of the ISRs claim the interrupt, which causes the operating system to dismiss the interrupt as spurious.

Conceptually, use of an ISR chain is computationally inefficient because multiple ISRs are called, but only one services the interrupt. In practice, however, in many situations, the latency penalty is relatively small and is considered an acceptable trade off for reduced design complexity. However, when the concept of an ISR chain is applied to a system running multiple virtual machines, the overhead involved with executing multiple ISR chains becomes increasingly detrimental to overall system performance.

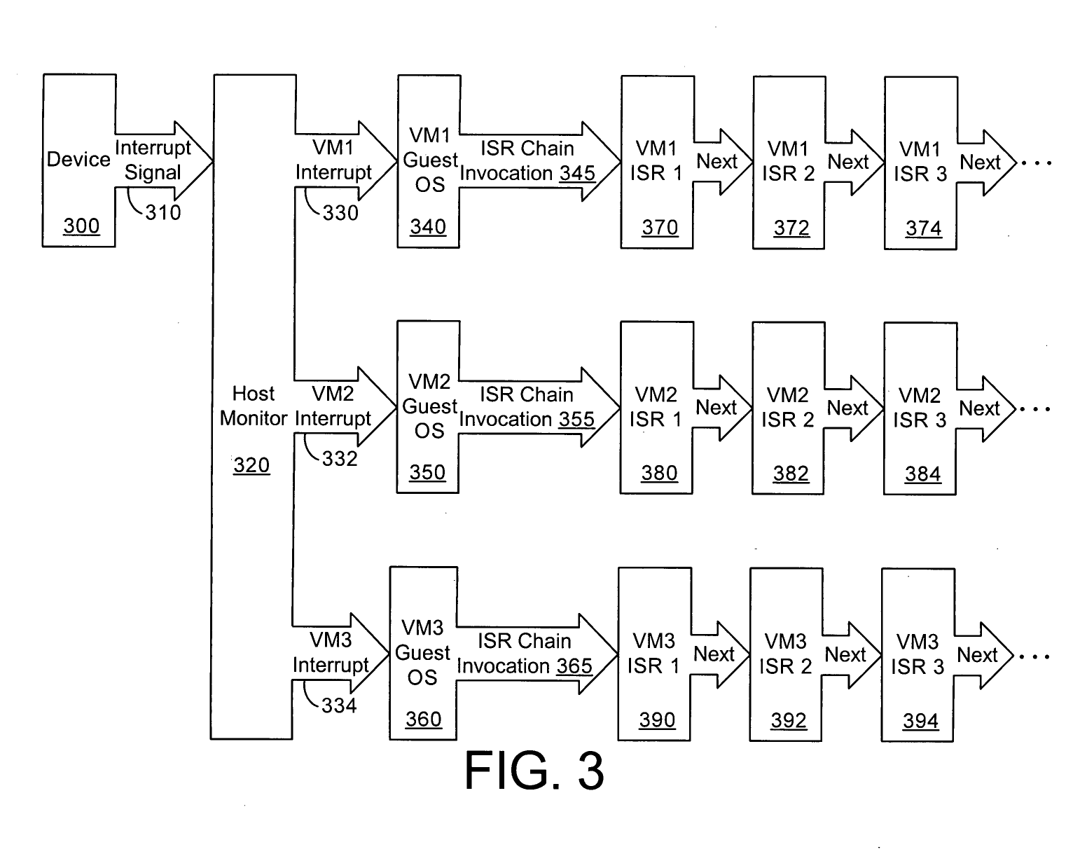

FIG. 3 is a conceptual illustration of interrupt processing with multiple virtual machines each using an interrupt service routine chain. Device 300 asserts interrupt signal 310 that is communicated to host monitor 320. Traditionally, determining the source of an interrupt signal on a shared interrupt interface is performed by software that is aware of the programming interface of the device. In a virtual machine environment, the awareness is provided by operating system specific device drivers running on the respective virtual machines and thus cannot be utilized by the host monitor to determine the source of the interrupt signal.

In the example of FIG. 3, when host monitor 320 receives the interrupt signal, a virtual machine interrupt signal (e.g., VM1 Interrupt 330, VM2 interrupt 332, VM3 interrupt 334) is generated for each virtual machine running on the host machine. The virtual machine interrupt signals are interpreted by the respective virtual machine operating systems (e.g., Virtual Machine 1 Guest OS 340, Virtual Machine 2 Guest OS 350, Virtual Machine 3 Guest OS 360) to invoke ISR chains (e.g., ISR chain invocation 345, ISR chain invocation 355, ISR chain invocation 365) for the respective virtual machines.

Each ISR chain includes multiple ISRs that are not the ISR required for processing the interrupt. For example, assuming an ISR registered with Virtual Machine 3 Guest OS 360, ISR chain 1 that can include ISRs 370, 372 and 374 as well as additional ISRs and ISR chain 2 that can include ISRs 380, 382 and 384 as well as additional ISRs treat the interrupt signal as a spurious interrupt. This amplifies the computational inefficiencies of the single ISR chain case described above. In addition to the inefficiencies of the ISR chains, there is a context switch overhead involved that can cause greater computational inefficiencies.

As the interrupt is processed by ISR chain 3 that can include ISRs 390, 392 and 394 as well as additional ISRs, traditional ISR chain processing identifies the proper ISR for the interrupt from device 300. As illustrated by the example of FIG. 3, the use of multiple ISR chains in a virtual machine environment can result in significant resource consumption. As the number of virtual machines increases and/or the number of ISRs in the ISR chains increases the inefficiencies increase. As described below, some (or even all) of the inefficiencies of the architecture of FIG. 3 can be eliminated to provide a more efficient interrupt processing technique in a virtual machine environment.

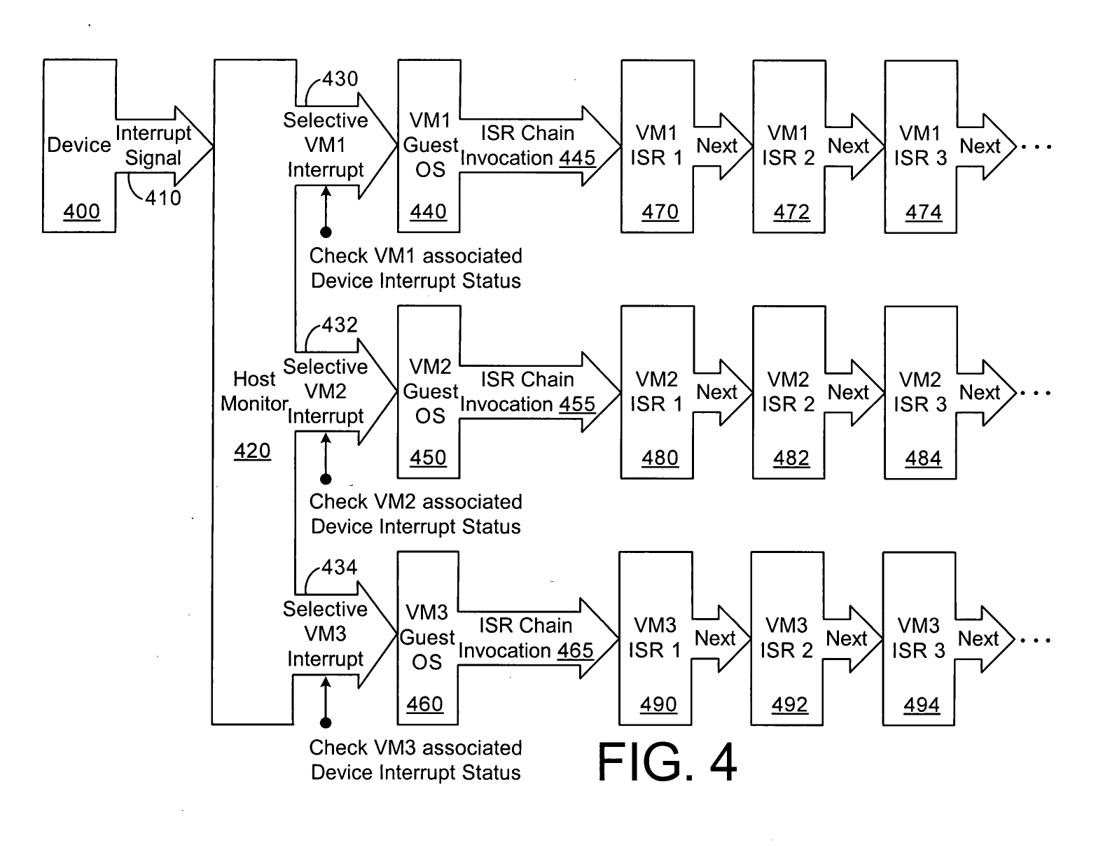

FIG. 4 is a conceptual illustration of interrupt processing with multiple virtual machines each using an interrupt service routine chain in which interrupt signals are selectively passed to one or more virtual machine operating systems. While the techniques of FIG. 4 are described with respect to a virtual machine environment, these techniques can be used in alternate environments, for example, in a multi-threaded environment.

Device 400 asserts interrupt signal 410 that is communicated to host monitor 420. Interrupt signal 410 is communicated to host monitor, at least in part, over a shared interface, for example, a bus conforming to certain versions of the PCI standards. When host monitor 420 responds to an interrupt signal assertion, an interrupt status bit corresponding to each of the devices sharing the interrupt signal are checked to determine the source of the interrupt signal. The PCI Local Bus Specification, Revision 2.3 published Mar. 29, 2002 as well as the PCI Express Base Specification, Version 1.0 published Jul. 23, 2002 and Version 1.0 a published Oct. 7, 2003 define an interrupt status bit in the PCI Status register of devices conforming to these specifications. For example, the interrupt status bit is defined as bit 3 of the device status register in Section 6.2 PCI Local Bus Specification, Revision 2.3. Subsequent standards may also define the interrupt status bit or provide another interrupt status indication that can be used as described herein.

Host monitor 420 can then use the identity of the device to determine which virtual machines are associated with the identified device. Host monitor then selectively generates (or passes) interrupt signals only for (or to) the virtual machines that are associated with the device generating the interrupt. This is illustrated in FIG. 4 by Selective VM1 interrupt 430, Selective VM2 interrupt 432 and Selective VM3 interrupt 434.

The selective interrupt signals are only generated for the virtual machines associated with the device generating the interrupt. In one embodiment, the selective interrupt signals include an identifier corresponding to the device asserting the interrupt signal. In alternate embodiments, the selective interrupt signals do not include the device identifier. The selective interrupt signals can be a version of interrupt signal 410 that is selectively passed to selected virtual machines. That is, interrupt signal 410 can be blocked from virtual machines that do not have access to the device asserting interrupt signal 410.

The interrupt status bit in the PCI Status register is described in the PCI standards as a building block type of functionality without any specific usage. Thus, the PCI standards do not define use of the interrupt status bit as described herein.

The technique of FIG. 4 avoids unnecessary context switch performance penalties for virtual machines that would otherwise have processed the interrupt as a spurious interrupt signal. Note that there is no possibility for loss of interrupts due to the level triggered nature of the interrupt signal. Host monitor 420 can share level triggered interrupts between devices assigned to separate guest virtual machines without incurring context switch penalties for virtual machines that are not associated with a device asserting the interrupt signal.

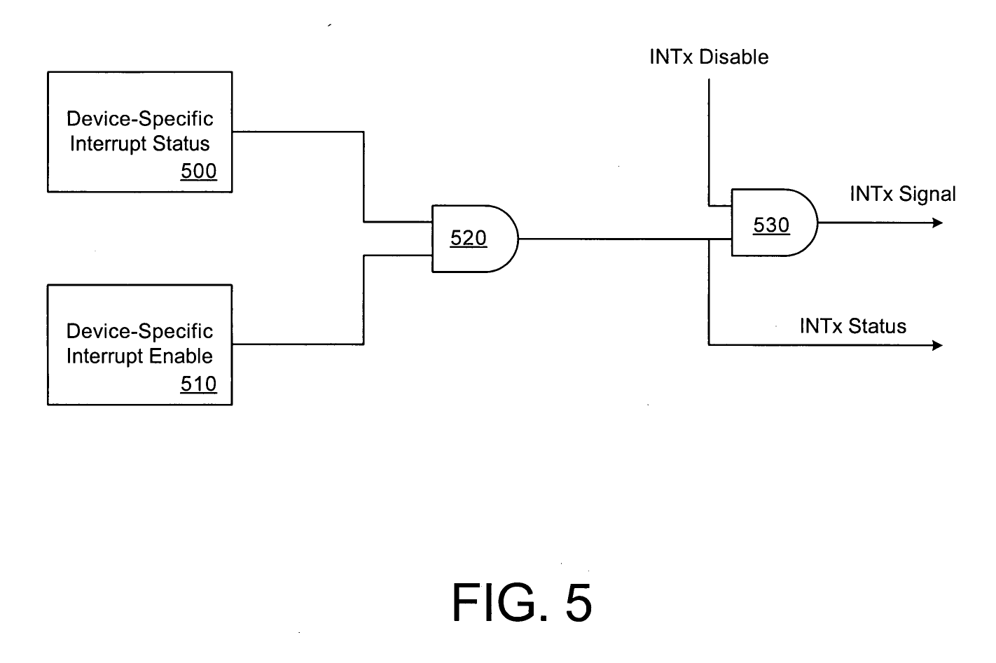

FIG. 5 is a block diagram of one embodiment of a circuit for selective assertion of interrupt signals to virtual machines. In one embodiment, the circuit of FIG. 5 is implemented for each device having the ability to assert an interrupt signal via a shared interrupt interface (e.g., a PCI bus). Variations of the circuit of FIG. 5 can be used to achieve the same or a similar result.

Device-specific interrupt status indicator 500 provides an indication of whether an associated device has asserted a shared interrupt signal. For example, interrupt status indicator 500 can be a register having one or more bits indicating interrupt status of one or more devices. Device-specific interrupt enable indicator 510 operates to enable checking of device-specific interrupt status indicator 500 as both indicators are coupled to provide input signals to logic gate 520. In one embodiment, logic gate 520 is an AND gate. Alternate embodiments, of determining whether a specific device has asserted an interrupt signal on a shared interrupt interface can also be used.

The output of logic gate 520 is the INTx Status signal, which indicates whether the corresponding device is asserting the interrupt signal. The INTx Status signal also indicates whether the device is asserting the interrupt signal when the INTx signal is disabled by the INTx Disable signal. In one embodiment, the INTx Disable signal and the INTx Status signal are input signals to logic gate 530, which generates the INTx signal. In one embodiment, logic gate 530 is an AND gate.

The INTx signal is the interrupt signal that is propagated over the shared interrupt interface (e.g., a bus conforming to PCI 2.3 or PCI Express). By monitoring the INTx signals and the corresponding INTx Status signals, the host monitor can determine the device that has asserted the interrupt signal.

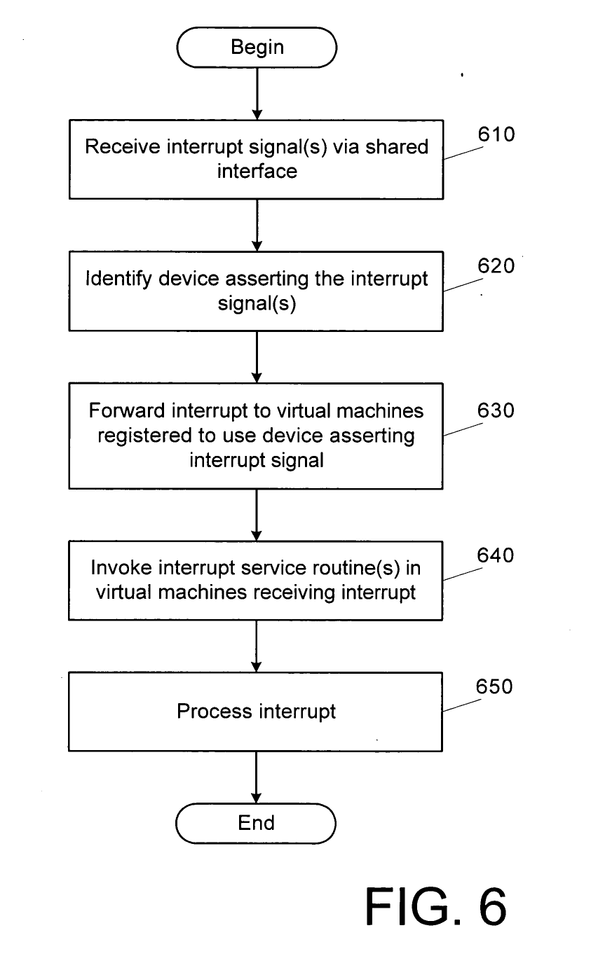

FIG. 6 is a flow diagram of one embodiment of a technique for selective assertion of interrupt signals to virtual machines. An interrupt signal is received via a shared interface, 610. As mentioned above, the shared interface can be, for example, a PCI bus, or a bus conforming to a different standard that allows multiple devices to share an interrupt signal.

The device that asserted the interrupt signal is identified, 620. The device asserting the interrupt signal can be identified, for example, via a register having an interrupt status bit as in the PCI Express standard, or via a non-standard register. In one embodiment, a host monitor determines the device that asserted the interrupt signal and also determines the virtual machines (or, alternatively, the threads) having access to the device that asserted the interrupt signal.

An interrupt indication is forwarded to the virtual machines (or threads) that are registered to use the device that asserted the interrupt signal, 630. In one embodiment, the interrupt indication includes an identifier of the device. In alternate embodiments, the interrupt indication does not include the device identifier, but is a forwarded version of the originally asserted interrupt signal.

The virtual machines that receive the interrupt indication invoke one or more interrupt service routines to process the interrupt, 640. In one embodiment, each virtual machine invokes an interrupt service routine chain to process the interrupt. The interrupt is processed by one of the interrupt service routines invoked by one of the virtual machines, 650.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method comprising:
receiving an interrupt message from a device via a shared interrupt interface;
checking one or more registers to identify the device; and
transmitting an indication of the interrupt message to one or more selected operating entities based on the identity of the device.

2. The method of claim 1 wherein the one or more selected operating entities comprises one or more virtual machines.

3. The method of claim 1 wherein the one or more selected operating entities comprises threads in a multi-threaded operating environment.

4. The method of claim 1 wherein the one or more registers comprise at least one Peripheral Component Interconnect (PCI) Status register for one or more corresponding devices.

5. The method of claim 4 wherein the PCI Status register conforms to the PCI Bus Standard, Version 2.3 or higher.

6. The method of claim 4 wherein the PCI Status register conforms to the PCI Express Bus Standard, Version 1.0 or higher.

7. The method of claim 1 wherein the one or more virtual machines comprise virtual machines that registered to have access to the identified device.

8. The method of claim 1 further comprising executing an interrupt service routine chain with each of the one or more virtual machines.

9. The method of claim 1 wherein the shared interrupt interface comprises a bus that conforms to a Peripheral Component Interconnect (PCI) standard.

10. The method of claim 1 wherein transmitting an indication of the interrupt message to one or more virtual machines based on the identity of the device comprises transmitting an identity of the device.

11. An article comprising a computer-accessible medium having stored thereon instructions that, when executed, cause one or more processors to:
receive an interrupt message from a device via a shared interrupt interface;
check one or more registers to identify the device; and
transmit an indication of the interrupt message to one or more selected operating entities based on the identity of the device.

12. The article of claim 11 wherein the one or more selected operating entities comprises one or more virtual machines.

13. The article of claim 11 wherein the one or more selected operating entities comprises threads in a multi-threaded operating environment.

14. The article of claim 11 wherein the one or more registers comprise at least one Peripheral Component Interconnect (PCI) Status register for one or more corresponding devices.

15. The article of claim 14 wherein the PCI Status register conforms to the PCI Bus Standard, Version 2.3 or higher.

16. The article of claim 14 wherein the PCI Status register conforms to the PCI Express Bus Standard, Version 1.0 or higher.

17. The article of claim 11 wherein the one or more virtual machines comprise virtual machines that registered to have access to the identified device.

18. The article of claim 11 further comprising instructions that, when executed cause the one or more processors to execute an interrupt service routine chain with each of the one or more virtual machines.

19. The article of claim 11 wherein the shared interrupt interface comprises a bus that conforms to a Peripheral Component Interconnect (PCI) standard.

20. The article of claim 11 wherein the instructions that cause the one or more processors to transmit an indication of the interrupt message to one or more virtual machines based on the identity of the device comprise instructions that, when executed, cause the one or more processors to transmit an identity of the device.

21. An apparatus comprising:
a plurality of virtual machines having associated respective operating systems;
a host monitor communicatively coupled with the plurality of virtual machines and coupled to receive an interrupt signal via a shared interrupt interface, wherein the host monitor reads a value stored in one or more registers corresponding to devices that asserted the interrupt signal to identify the device, and further wherein the host monitor selectively invokes an interrupt service signal to each of the plurality of virtual machines associated with the device asserting the interrupt signal.

22. The apparatus of claim 21 wherein the one or more registers comprise at least one Peripheral Component Interconnect (PCI) Status register for one or more corresponding devices.

23. The apparatus of claim 22 wherein the PCI Status register conforms to the PCI Bus Standard, Version 2.3 or higher.

24. The apparatus of claim 22 wherein the PCI Status register conforms to the PCI Express Bus Standard, Version 1.0 or higher.

25. The apparatus of claim 21 wherein each virtual machine receiving the interrupt service signal from the host monitor executes at least one interrupt service routine.

26. The apparatus of claim 21 wherein the shared interrupt interface comprises a bus that conforms to a Peripheral Component Interconnect (PCI) standard.

27. The apparatus of claim 21 wherein the interrupt service signal comprises an identifier of the device.

28. A system comprising:
a memory controller; and
an article communicatively coupled with the memory controller, the article comprising a computer-accessible medium having stored thereon instructions that, when executed, cause one or more processors to receive an interrupt message from a device via a shared interrupt interface, check one or more registers to identify the device, and transmit an indication of the interrupt message to one or more operating entities based on the identity of the device.

29. The system of claim 28 wherein the one or more selected operating entities comprises one or more virtual machines.

30. The system of claim 28 wherein the one or more selected operating entities comprises threads in a multi-threaded operating environment.

31. The system of claim 28 wherein the one or more registers comprise at least one Peripheral Component Interconnect (PCI) Status register for one or more corresponding devices.

32. The system of claim 31 wherein the PCI Status register conforms to the PCI Bus Standard, Version 2.3 or higher.

33. The system of claim 31 wherein the PCI Status register conforms to the PCI Express Bus Standard, Version 1.0 or higher.

34. The system of claim 28 further comprising instructions that, when executed cause the one or more processors to execute an interrupt service routine chain with each of the one or more virtual machines.

35. The system of claim 28 wherein the shared interrupt interface comprises a bus that conforms to a Peripheral Component Interconnect (PCI) standard.
